(19) United States
(12) Patent Application Publication
(10) Pub. No.: US 2002/0141712 A1
(43) Pub. Date: Oct. 3, 2002

(54) Coated steel tape

(76) Inventors: Lawrence O'Connor, Winnipeg (CA); Robert J. Krul, Winnipeg (CA)

Correspondence Address: ADE & COMPANY, 1700-360 MAIN STREET, WINNIPEG, MB, R3C3Z3, CA

(21) Appl. No.: 09/820,167

(22) Filed: Mar. 29, 2001

(51) Int. Cl. G02B 6/44

(52) U.S. Cl. 385/107; 242/430; 428/906

(57) ABSTRACT

A fiber optic cable is manufactured by wrapping a cable core with a corrugated steel reinforcing tape coated on each surface by a polymer material and extruding a jacket over the tape such that the polymer material on the outer surface is bonded to the jacket and the edges of the tape are overlapped and bonded. The tape is formed and spooled so as to be continuous through the spool to a required length to match the intended length of the cable which can be as much as 18 to 30 kms. The required length of the tape is obtained by slitting master rolls of steel web into individual tapes and forming welded butt splices in the steel so that each spooled tape is of the required length. A series of the spooled tapes are then unwound side by side, simultaneously laminated with two sheets of the polymer, separated each from the next and re-wound to form a spool of single tape of the required length. If the tapes are spaced side to side, the polymer material encapsulates the tape edges also.

This invention relates to a coated steel tape and to a method for manufacturing the coated steel tape for use, for example in forming a sheath in a fiber optic cable.

### BACKGROUND OF THE INVENTION

The coated steel tape and the method of manufacture described herein is primarily but not exclusively designed for use as a reinforcing sheath in a fiber optic cable. However other end uses are also possible. Fibre optic cables are widely used for transmitting light signals over large distances in telecommunications, transmission of television signals and other uses. Such cables can be buried or can be above ground but in both cases the cable needs to be protected to prevent physical damage and to prevent penetration of contaminants.

It is well established that it is highly desirable that the cable provide as long as possible of an uninterrupted length so that the individual transmission fibres can be as long as possible without the necessity for splicing. Splicing of the fibres is of course problematic in that it is necessary to ensure proper communication of the light signals through the splice. In addition, splicing of the cable is problematic in that it is necessary to maintain the proper protection of the cable against physical damage and contaminant penetration also at the splice.

Attempts have therefore been made over recent years to increase as much as possible the length of a continuous cable portion and, at the present time, often this length can reach as much as 18 km, with attempts being made to increase that length up to 30 km.

Fibre optic cables generally include a central core of the individual fibres which may then be surrounded by a jacket extruded around the fibres to consolidate the fibres and to protect the fibres against contaminant penetration. Around this inside core defined by the inner jacket and the fibres is wrapped a reinforcing sheath formed from a steel tape which is covered on both of its surfaces by a polymer layer bonded to the surface.

For the proper understanding of the reader, a tape is defined herein as a length of material having a width significantly greater than its thickness so that the tape defines two tape surfaces which are relatively wide and two tape edges which are relatively narrow and equal to the thickness of the tape.

In the cable, the tape is wrapped around the core so as to form the sheath co-axially surrounding the core with edges of the tape overlapping. Generally prior to or during the wrapping process, the tape is corrugated transversely with relatively shallow corrugations which extend across the full width of the tape.

After the sheath is applied and wrapped, a jacket is extruded over the outside surface of the sheath. The heat from the extrusion process is arranged to heat the tape and at least part of the cable so that the polymer material on the outside surface of the steel tape is bonded to the plastics material of the jacket as the jacket is extruded. Also the heat from the extrusion acts to bond the overlapping side edges of the tape so that an edge portion of the inner coating is bonded to an edge portion of the outer coating on the steel tape thus closing and sealing the steel tape around the cable core to form the closed sheath The heat from the extrusion process may also be sufficient to bond those parts of the inside surface of the tape to the jacket of the core. However it will be appreciated that the corrugations in the tape leaves some opportunity for the tape to be stretched. Thus allowing the cable to bend around a curve without fracturing the part of the tape on the outside of the curve or forming kinks in the part of the tape on the inside of the curve.

Up till now the steel reinforcing tape including the inner and outer coating layers has been manufactured by providing a web of the steel sheet. This web is then unrolled and is laminated by heat bonding with two webs of similar width each forming the polymer material for a respective surface of the tape. After laminating on the upper and lower surfaces of the steel web is complete, the steel including the two laminated sheets of polymer material are then cut longitudinally to divide the web into a series of side by side tapes which are then individually wound.

As the master supply roll has a relatively short length, the finished tape roll has the same length and generally this is wound into a pancake roll.

In conventional manufacture of the fibre optic cable, therefore, these supply rolls of the steel reinforcing tape are supplied to the cable manufacturing line. In order to manufacture a cable of for example 18 kms, therefore, it is necessary to splice end to end a series of these tape pieces so that the tape is thus continuous through the length of the cable. Up till now this has been conventionally completed splicing onto a trailing end of the tape the lead end of the next roll of tape. This requires the provision of an accumulator which allows the tape to be supplied continuously to match the continuous feed of the cable.

The splicing is effected by peeling back or burning off the polymer material on the inner and outer surfaces over a short distance and connecting the tail steel end to the leading steel end of the next tape by welding. In most cases, the steel tape at the splice is then re-covered by replacing the ends of the polymer material or by an additional polymer patch. In some limited uses, however, the steel splice is left un-covered presumably on the assumption that the probability of the penetration of contaminants at that location is relatively small.

It will be appreciated in this regard that it is necessary that the steel tape itself is continuous along the cable since the steel tape is used for conducting electrical signals.

In order to provide a package of tape having a length sufficient to match the length of the cable, some limited commercial arrangements have used a spool of tape rewound from the individual relatively short length pancake rolls of the reinforcing tape. In order to form a continuous tape from the short length pancake rolls, it is of course necessary to form splices at the junction between each tape and the next. These splices are effected using the conventional splicing technique in which the polymer coating layer is peeled back or burnt off and the ends of the steel tape welded together. It is believed that the polymer coating layers are then patched. This technique provides a technically inferior product with a reduced quality of coating and less effective splice.

In prior art arrangements and therefore preferably used in the present invention, the steel tape generally has a thickness which provides sufficient stiffness and strength for protecting the cable in conventional situations. However it will be appreciated that the present invention is not limited to this conventional thickness. In the prior art, depending upon the dimensions and construction of the cable, the width of the tape can vary between 0.75 inches and 4 inches. Again it is appreciated that the invention is not limited to these dimensions.

In general the polymer coatings are provided so as to fulfil the above stated functions and any suitable material which allows the functions to be effected at temperatures suitable for the extrusion process can be utilized. The thickness of the polymer coatings is maintained as thin as possible so as to minimize the total thickness of the finished tape structure while providing the necessary bonding action.

### SUMMARY OF THE INVENTION

It is one object of the present invention, therefore, to provide an improved steel tape.

According to a first aspect of the invention, therefore, there is provided a method of manufacturing a tape comprising:

providing at least two webs of sheet steel;

slitting a first of the webs into a plurality of side by side steel tapes;

winding each of the steel tapes into a respective tape package;

at a tail end of the first web, splicing to the tail end of the first web a leading end of a second of the webs to form a splice in the webs and continuing the slitting and winding of the tapes such that each of the steel tapes when wound onto the respective package has a length through the splice of the sum of the length of the webs;

unwinding at least one of the steel tape packages and in a laminating station laminating onto each surface of the steel tape a respective layer of a polymer material so as to cover the surface and to form a finished tape;

and re-winding the finished tape into a finished tape package.

Thus the finished tape, when used for fiber optic cable, can therefore be manufactured with a length equal to the required length of the cable without the necessity for splicing during the cable manufacturing. The finished structure has an enhanced properties for forming the sheath since there is no break in the polymer coating nor any deterioration of the coating at the splices. The ability to splice the steel web while stationary allows an effective splice to be formed in the steel which avoids adversely affecting the properties of the steel for protection and conduction.

Preferably a plurality of the steel tapes are unwound and passed through the laminating station in which the steel tapes are arranged side by side and are laminated, while side by side, with two sheets of the polymer material such that each of the sheet of the polymer material bridges the plurality of steel tapes and covers the respective surface of the steel tapes to form a plurality of the finished tapes side by side, and wherein, after laminating, the sheets are divided longitudinally to separate each finished tape from the next. However the tapes can also be laminated individually.

Preferably the side by side steel tapes are arranged in the laminating station spaced each from the next such that the sheets of the polymer material are laminated together between the steel tapes to effect encapsulation of the steel tapes and to cover the side edges of the steel tapes with the polymer material.

However, the steel tapes can also be arranged in the laminating station directly side by side such that the sheets of polymer material cover only the surfaces of the tapes and, when subsequently separated, leave the edges of the steel tapes exposed.

Preferably the leading end of the second web is butt spliced to the trailing end of the first web such that each finished tape has at least one butt splice of the steel tape therein. Other types of splices such as overlap splices can also be used. Preferably the butt splice is effected by welding but adhesive may be possible in some circumstances. Preferably the butt splice is at an angle to a line transverse to the steel tape.

The above method provides a construction in which the sheets of polymer material are continuous through the splice in the steel tape. Thus the term “continuous” herein is intended to distinguish from arrangements in which the coating material is patched or overlapped or otherwise discontinuous.

In an optional improvement, the method can be enhanced by applying onto one of the sheets of polymer material a water swellable material so as to be carried as a strip on the finished tape which is covered by a moisture permeable covering protective layer.

Preferably the water swellable material is spaced from one side edge of the finished tape so that it forms a band narrower than the width of the tape.

According to a further aspect of the invention, the above method for manufacturing the tape forms part of a method for manufacturing a fiber optic cable comprising:

providing a cable core including at least one optical fiber;

providing a reinforcing tape for the core having a steel reinforcing layer coated on each of an outer surface and an inner surface by a polymer material;

wrapping the tape around the core so as to surround the core and define an edge of the inner surface which overlaps an edge of the outer surface;

and extruding a jacket over the tape such that the tape is heated to effect bonding of the polymeric material on the outer surface to the jacket and to effect bonding of polymeric material at the edge of the inner surface to the polymeric material at the edge of the outer surface;

forming the cable over a predetermined continuous required length;

and providing the finished tape in a supply having a continuous supplied length at least equal to said required length.

According to a second aspect of the invention there is provided a package of tape for use in manufacturing a fiber optic cable comprising:

a steel tape;

the steel tape including at least one splice therein, which is preferably a welded butt splice, such that the strip is continuous through the package from a leading end to a trailing end;

the steel tape having laminated onto each surface of the steel tape a respective layer of a polymer material so as to cover the surface;

the layers of polymer material being continuous through the at least one butt splice.

### BRIEF DESCRIPTION OF THE DRAWINGS

Embodiments of the invention will now be described in conjunction with the accompanying drawings, in which:

FIG. 1 is a longitudinal cross sectional view of a fiber-optic cable according to the present invention.

FIG. 2 is a transverse cross sectional view of the cable of FIG. 1.

FIG. 3 is a longitudinal cross sectional view of first portion a steel reinforcing tape for use in the fiber-optic cable of FIG. 1.

FIG. 4 is a longitudinal cross sectional view of second portion a steel reinforcing tape for use in the fiber-optic cable of FIG. 1.

FIG. 5 is a transverse cross sectional view of a first embodiment of a steel reinforcing tape for use in the fiber-optic cable of FIG. 1.

FIG. 6 is a transverse cross sectional view of a second embodiment of a steel reinforcing tape for use in the fiber-optic cable of FIG. 1.

FIG. 7 is a side elevational view of a first part of a method for manufacturing the steel reinforcing tape for use in the fiber-optic cable of FIG. 1.

FIG. 8 is a top plan view of the first part of a method of FIG. 7.

FIG. 9 is a side elevational view of a second part of a method for manufacturing the steel reinforcing tape for use in the fiber-optic cable of FIG. 1.

FIG. 10 is a cross sectional view on the lines 10-10 of FIG. 9.

FIG. 11 is a schematic illustration of a method for manufacturing the fiber-optic cable of FIG. 1 using the tape manufactured by the method shown in FIGS. 7 and 9.

In the drawings like characters of reference indicate corresponding parts in the different figures.

### DETAILED DESCRIPTION

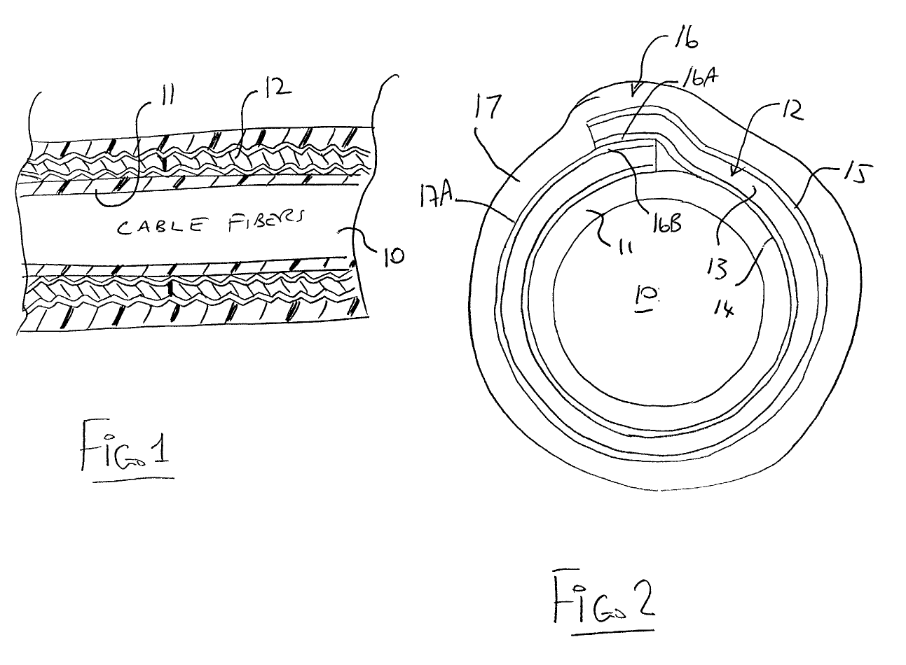

In FIGS. 1 and 2 is shown schematically a fiber optic cable. This comprises a cable core 10 defined by a plurality of optical fibers together with an optional surrounding jacket 11 which together form a cable core. This area is shown only schematically since the specific construction of the cable core is well known to one skilled in the art and can vary in accordance with requirements.

Around the cable core is wrapped a reinforcing sheath 12 which has a central layer 13 of steel tape together with an inner polymer material layer 14 and an outer polymer material layer 15. As shown in FIG. 1, the tape is corrugated with transverse corrugations so that the inside surface of the tape forms a wavelike shape with portions in contact with the outside surface of the core and portions spaced away from the outside surface of the core. This allows the complete cable to bend so that on the outside curvature of the bend the tape straightens and on the inside curvature the corrugations increase in depth thus allowing the cable to bend without fracturing the tape or causing damaging kinks.

The tape is overlapped at the area 16 so that a portion 16A of the inside layer 14 overlaps a portion 16B of the outside layer 15 so that these overlapping portions can be heat bonded together to seal the tape as a sheath surrounding the core. On the outside surface of the outside layer 15 is extruded a jacket 17. The heat from the extrusion process acts to bond the inside surface 17A of the jacket to the outside layer 15.

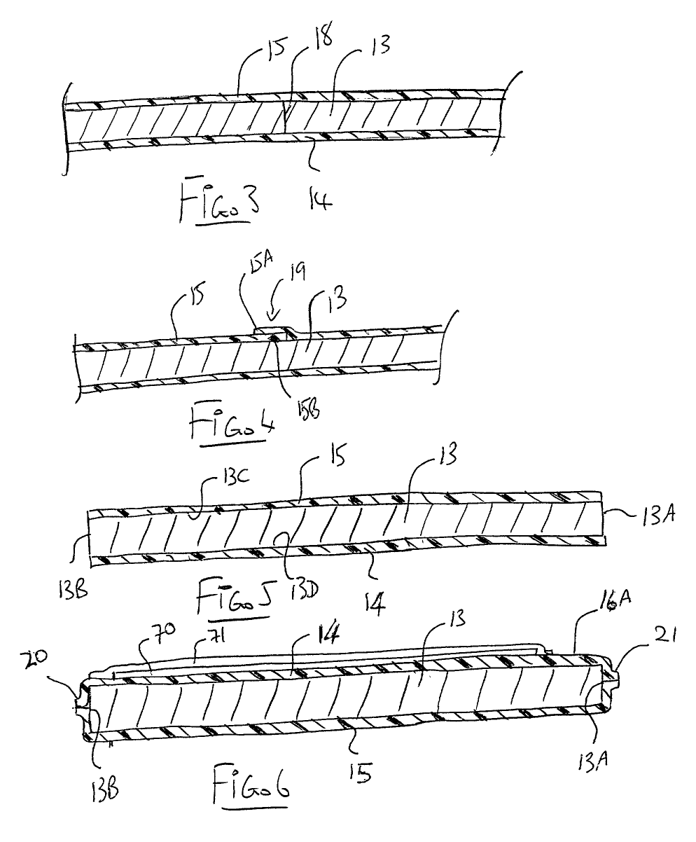

The details of the tape are shown in FIGS. 3 to 6. As shown in FIG. 3 the steel tape 13 includes a butt splice 18 where an end of a first portion is directly butted against an end of a second portion and the two ends are welded together. Such a butt splicing technique is commercially available for butt splicing sheets of steel and the finished butt splice provides a smooth surface at the top and bottom surfaces of the tape so that in effect the steel is continuous through the butt splice and its properties are not affected by the butt splice. The steel tape is thus conductive through the butt splice and its strength is at least sufficient to effect the required purposes at the butt splice.,

As shown in FIG. 3 the coating layers 14 and 15 are continuous through the butt splice so that the butt splice is fully covered by the covering layers.

In FIG. 4 is shown a further portion of the tape in which the steel tape 13 is continuous without any splices but one or both of the layers includes a splice as indicated at 19. In the embodiment shown the splice 19 is in the upper layer 15 and there is no corresponding splice in the lower layer 14 since the splices occur simply at a location where the covering layer terminates and the second portion of the layer is spliced to that end as described hereinafter. In the embodiment shown, therefore, the splice is effected by overlapping an upper portion 15A over an inner portion 15B and those portions are heat sealed together prior to laminating to the steel strip 13.

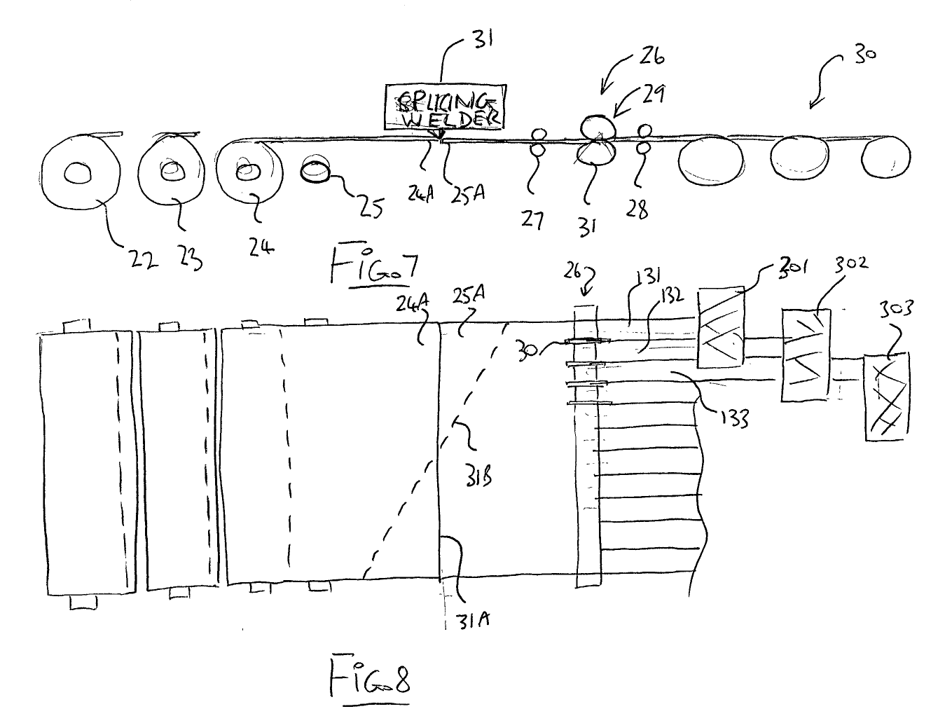

As shown in FIG. 5 is a cross section of the tape in one embodiment in which the steel tape 13 has side edges 13A and 13B which are exposed and only the surfaces 13C and 13D of the tape are covered by the layers 14 and 15 respectively.

In a second embodiment of the tape as shown in FIG. 6, the steel tape 13 is covered by the layers 14 and 15 as previously described, but in this embodiment the side edges 13A and 13B are also covered by heat sealed portions 20 and 21 of the polymer material formed by the method as described hereinafter.

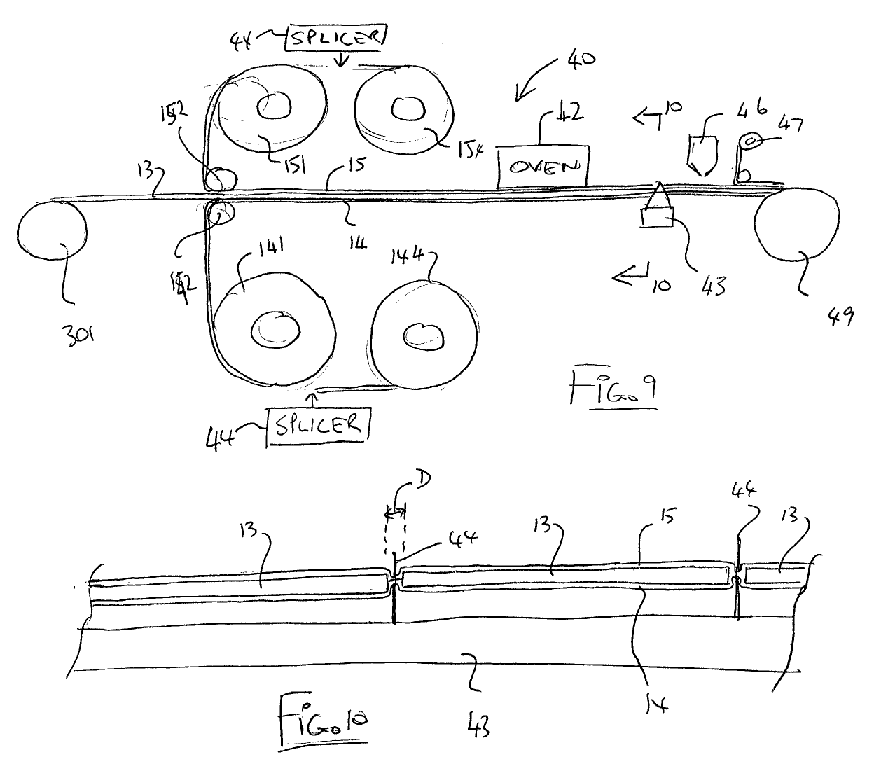

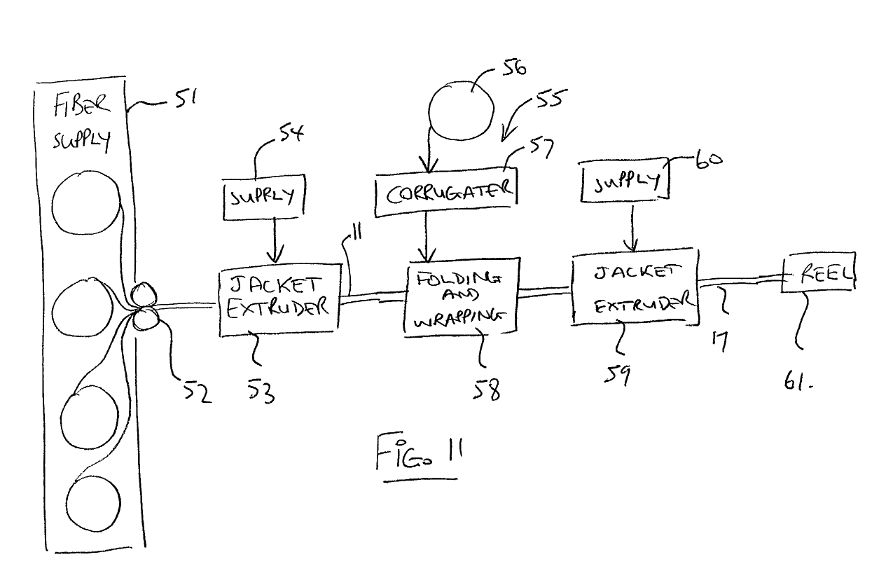

Turning now to FIGS. 7 through 10, there is shown the method of forming the tapes as described above. FIGS. 7 and 8 show a first step in the method and FIGS. 9 and 10 show a second step in the method.

Thus in the first step in the method, a plurality of webs 22, 23, 24 and 25 of sheet steel material are provided and arranged in a supply. The web from each roll is unrolled in turn and fed through a slitting system indicated schematically at 26. The slitting system includes feed rollers 27 and 28 which control attention and drive of the web through the slitting system together with slitting rollers 29 which include blades 30 operating on an anvil roller 31 so as to effect a slitting action through the web of sheet steel to slit the web into a plurality of individual tapes 131, 132, 133, etc. suitable slitters are well known to one skilled in the art. After slitting, each tape 131, 132, 133 is wound into a respective tape package 301, 302, 303 of a winding system schematically indicated at 30. The tape package can be a spool or reel.

After the first web from the supply roll 25 is fully unwound, a trailing edge 25A of the web is located at a splicing system schematically indicated at 31., A leading edge 24A of the next web from the supply is brought up to the trailing edge 25A and the edges are butt spliced using the splicing welder 31 of a conventional nature. As shown in full line at 31A, the splice is directly transverse across the full width of the webs prior to the slitter 26. However as shown in dotted line 31B, the splice can also be arranged diagonally or at an angle to a line transverse to the webs. This provides a diagonal splice in the finished tape which may be more effective in passing through the folding mechanisms described hereinafter for completing the manufacture of the cable.

The splice is effected by the splicer 31 while the webs are held stationary so that the splice can be effected using the necessary time to generate a clean high quality splice. Subsequently the feed of the webs through the slitting system 26 is restarted and the slitting and rolling of the tapes into the individual packages 301, 302, 303 is continued. The splicing is then repeated at the end of each of the rolls 22, 23, 24 and 25 to form a package of tape which is equal to the required length for manufacturing a required length of cable. This can be as much as 18 km up to 30 km as previously described with the limitations on length being determined by other characteristics rather than the lengths of the tape.

The tape packages 301, 302, 303 can be traverse wound spools in which the position of the tape is moved axially along the cylindrical surface of the core so as to provide a long length of tape wound on the core. The traverse may be continuous or may be in a stepped manner as is well known in the art.

The package can be of the spool type in which there is simply a core on which the packages wound and is self supporting or it may be of the reel type in which the package includes end flanges so as to support and stabilize the tape against longitudinal sliding.

In FIGS. 9 and 10 is shown the second part of the method in which one or more of the tapes are unwound from the respective supply package 301, 302, 303. In a side elevational view of FIG. 9 only one of the packages can be seen but it will be appreciated that the other packages are arranged side by side so as to supply the tapes side by side as shown in FIG. 10. It is preferable that the tapes be supplied simultaneously side by side for a more efficient processing although it is possible that the tapes may be processed in the method individually.

The tapes are then fed through a laminating station generally indicated at 40 in which the layers 14 and 15 are applied onto the tape 13. The layers 14 and 15 are supplied from supply rolls 141, 151 and the laminating station includes guide rollers 142, 152, together with an oven 42 which acts to heat bond the layers onto the steel tapes.

In the arrangement shown in FIG. 10, the tapes 13 are spaced by a short distance D sufficient to allow the layers 14 and 15 to contact one another between the tapes and thus laminate together at a neck in between the edges of the tapes.

After the laminating is complete, the tapes are passed over a slitter bar 43 with slitter knives 44 so as to separate the tapes at the neck leaving portions of the coating layers 14 and 15 overlapping the side edges of the tape 13 to form the construction as shown in FIG. 6. In an alternative arrangement, the tapes are arranged directly side by side so that the coating layers 14 and 15 simply lie over the surfaces of the tape and do not neck in between the tapes. At the slitting by the knives 44 therefore, the side edges 13A and 13B of the tapes are thus left exposed as shown in FIG. 5. The slit finished tapes are re-wound onto a reel or spool winder 49 of conventional construction arranged to wind the required full length of the finished tape into a single tape package.

Each of the supplies 141, 151 of the coating materials includes a splicer 44 so that each roll comes to its end, a further supply roll 144, 154 is brought up to the trailing end and spliced by a simple heat sealed overlapping splice as shown in FIG. 4. The splices in the polymer layers therefore occur at different locations from the splices in the steel tape.

Turning now to FIG. 11, there is shown a schematic illustration of a fiber optic cable manufacturing line. This comprises a fiber supply generally indicated at 51 which collates and supplies the fibers through a supply system 52 to a jacket extruder 53., The jacket extruder is supplied with a jacket polymer material 54 so that the fibers are coated around the core structure by the drive jacket 11.

Downstream of the extruder 53 is provided the sheath application system generally indicated at 55 which includes a supply 56 of the tape which feeds the tape into a corrugator 57 from which it extends into a folding and wrapping system generally indicated at 58.

After wrapping with the sheath formed by the tape, the sheath and the core are passed through a second extruder 59 supplied with polymer from a supply 60 so that the jacket 17 is extruded onto the outside surface of the tape as previously described. The heat from the extruder 59 is sufficient to effect the heat bonding of the tape at the overlapped section 16 and to effect the heat bonding of the jacket 17 to the layer 15 of the tape.

When complete the cable is wound into a reel 61. The length of the cable is predetermined and the materials are supplied in a sufficient continuous length to provide the required continuous length of cable. Thus the fibers are arranged to be of the required length and also the supply of the tape indicated at 56 is required to be of the same predetermined length. Thus one of the finished packages from the wound package structure 56 from the method of FIG. 9 is fed to the supply 56 of FIG. 11.

In FIG. 6 is shown an optional additional element which can be applied onto the tape. This comprises a layer of swellable material indicated at 70 which is covered by a permeable protective sheet 71 of for example paper or similar material which allows moisture to penetrate while maintaining the swellable material in position on top of the surface of the layer 14. The strip of the swellable material is less than the full width of the tape so that it leaves the overlapping edge portion 16A available for overlapping in the position of FIG. 2. Similarly the covering permeable material 71 is of reduced width relative to the width of the tape. In the embodiment shown the width of the strip is swellable material and the width of the permeable covering material is of the maximum width that is it extends from the edge of the overlapping section 16A across to the opposite edge of the tape. However the swellable material may be reduced in width if required so as to provide a band on the tape.

The swellable material and the covering permeable layer are both of a conventional nature and hence their materials and construction are well known to one skilled in the art.

The swellable material and the covering layer are applied during the laminating and slitting process of FIG. 9 in that an additional step is included downstream of the laminating system 40 and upstream of the winding arrangement 49. This can be provided by a series of powder application elements 46 and a series of strip applying elements 47 which allow the application of the swellable material and the covering strip onto the finished tapes prior to winding at the winding station 49.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

I claim:

1. A method of manufacturing a tape comprising:
providing at least two webs of sheet steel;
slitting a first of the webs into a plurality of side by side steel tapes;
winding each of the steel tapes into a respective tape package;
at a tail end of the first web, splicing to the tail end of the first web a leading end of a second of the webs to form a splice in the webs and continuing the slitting and winding of the tapes such that each of the steel tapes when wound onto the respective package has a length through the splice of the sum of the length of the webs;
unwinding at least one of the steel tape packages and in a laminating station laminating onto each surface of the steel tape a respective layer of a polymer material so as to cover the surface and to form a finished tape;
and re-winding the finished tape into a finished tape package.

2. The method according to claim 1 wherein a plurality of the steel tapes are unwound and passed through the laminating station in which the steel tapes are arranged side by side and are laminated, while side by side, with two sheets of the polymer material such that each of the sheet of the polymer material covers the respective surface of the plurality of steel tapes to form a plurality of the finished tapes side by side, and wherein, after laminating, the sheets with the steel tapes laminated therein are divided longitudinally to separate each finished tape from the next.

3. The method according to claim 2 wherein the side by side steel tapes are arranged in the laminating station spaced each from the next such that the sheets of the polymer material are laminated together between the side edges of the steel tapes to effect encapsulation of the steel tapes and to cover the side edges of the steel tapes with the polymer material.

4. The method according to claim 2 wherein the steel tapes are arranged in the laminating station directly side by side such that the sheets of polymer material cover only the surfaces of the tapes and, when subsequently separated, leave the edges of the steel tapes exposed.

5. The method according to claim 1 wherein the leading end of the second web is butt spliced to the trailing end of the first web such that each package of finished tape has at least one butt splice of the steel tape therein

6. The method according to claim 5 wherein the butt splice is effected by welding.

7. The method according to claim 5 wherein the butt splice is at an angle to a line transverse to the steel tape.

8. The method according to claim 1 wherein the sheets of polymer material are continuous through the splice in the steel tape.

9. The method according to claim 1 including applying onto one of the sheets of polymer material a water swellable material so as to be carried as a strip on the finished tape.

10. The method according to claim 9 wherein the water swellable material is covered by a moisture permeable covering protective layer.

11. The method according to claim 9 wherein the water swellable material is spaced from at least one side edge of the finished tape.

12. A method for manufacturing a fiber optic cable comprising:
providing a cable core including at least one optical fiber;
providing a reinforcing tape for the core having a steel reinforcing layer coated on each of an outer surface and an inner surface by a polymer material;
the tape being formed by a method according to claim 1;
wrapping the tape around the core so as to surround the core and define an edge of the inner surface which overlaps an edge of the outer surface;
and extruding a jacket over the tape such that the tape is heated to effect bonding of the polymer material on the outer surface to the jacket and to effect bonding of the polymer material at the edge of the inner surface to the polymer material at the edge of the outer surface;
forming the cable over a predetermined continuous required length;
and providing the finished tape, including the steel tape and the layers of the polymer material thereon, in a supply having a continuous supplied length at least equal to said required length.

13. The method according to claim 12 wherein the layers of polymer material are wrapped around the edges of the steel tape to effect encapsulation of the steel tape and cover the side edges of the steel tape with the polymer material.

14. The method according to claim 12 wherein the finished tape has at least one butt splice of the steel tape therein.

15. The method according to claim 14 wherein the butt splice is effected by welding.

16. The method according to claim 12 wherein the polymer material is continuous through the butt splice.

17. The method according to claim 12 wherein the tape is corrugated transversely.

18. A package of tape comprising:
a steel tape;
the steel tape including at least one splice therein such that the steel tape is continuous through the package from a leading end to a trailing end;
the steel tape having laminated onto each surface of the steel tape a respective layer of a polymer material so as to cover the surface;
the layers of polymer material being continuous through the at least one butt splice.

19. The package of tape according to claim 18 wherein the splice is a butt splice.

20. The package of tape according to claim 18 wherein the splice is welded.

21. The package of tape according to claim 18 wherein the layers of the polymer material are laminated together on each side edge of the steel tape to effect encapsulation of the steel tape and to cover the side edges of the steel tape with the polymer material.

22. The package of tape according to claim 18 wherein the splice is at an angle to a line transverse to the steel tape.

23. The package of tape according to claim 18 including a water swellable material on one of the sheets of polymer material so as to be carried as a strip on the finished tape.

24. The package of tape according to claim 23 wherein the water swellable material is covered by a moisture permeable covering protective layer.

25. The package of tape according to claim 9 wherein the water swellable material is spaced from at least one side edge of the finished tape.

26. A fiber optic cable comprising:
a cable core including at least one optical fiber;
a package of tape according to claim 18 wherein the tape is wrapped on the core as a sheath surrounding the core;
the tape being wrapped around the core so as to surround the core and define an edge of the inner surface which overlaps an edge of the outer surface and is heat bonded thereto;
and a jacket extruded over the tape and heat bonded to the polymer material on the outer surface;
the finished tape having a continuous length equal to the length of the cable.

27. The cable according to claim 26 wherein the layers of polymer material are wrapped around the edges of the steel tape to effect encapsulation of the steel tape and cover the side edges of the steel tape with the polymer material.

28. The cable according to claim 26 wherein the tape is corrugated transversely.
